(19) United States
(12) Patent Application Publication
(10) Pub. No.: US 2010/0246165 A1
(43) Pub. Date: Sep. 30, 2010

(54) Invisible and/ or non-invisible designed inflatables combined with electric black ultra-violet lights and inflator nozzle fixture accessories

(76) Inventors: Edmundo B. Diaz, Los Lunas, NM (US); Gilbert Paul B. Rico Diaz, Los lunas, NM (US)

Correspondence Address: EDMUNDO B. DIAZ;GILBERT PAUL B. RICO DIAZ, 25 MOUNTAIN SHADOW ROAD, LOS LUNAS, NM, 87031, US

(21) Appl. No.: 12/384,073

(22) Filed: Mar. 31, 2009

(51) Int. Cl. F21L 4/00

(52) U.S. Cl. 362/183; 362/157

(57) ABSTRACT

Itemized inflatables and their accessories relating generally to party, advertising, and, ornamental goods and supplies are disclosed herein to include invisible and/or non-invisible (visible) designed clear transparent inflatables made of diversified materials of varying sizes, shapes, and, forms, extently using fluorescent, phosphorescent, and, standard (invisible and/or visible) paint means, said inflatables resiliently adhesively combined with multiple varieties of electric (battery operated) black ultra violet lights and standard lights fixtures, adaptedly comprising numerous different and common inflator nozzle means, so as to permit said inflatables to demonstrably emanate, never before seen, out of the ordinary distinct iluminations of carefully, strategically, and, articulately positioned designed images, that appear and disappear in whole or in part, from the hidden to the visible and back to obscurity, thereby, imparting to viewers, continual repetitions of unique, dramatic, multiple stupendous, exciting visual displays and effects, of truly unlimited epic proportions.

### FIELD OF INVENTION

The present invention relates generally to Fluorescent paints and/or inks (Clear invisible or visible), Phosphorescent paints and/or inks (Glow in the dark paints), electric/battery operated light fixtures accessories and inflator nozzles, which are now being used and adapted in a variety of ways in sports, party supplies, circuses and amusements for fun, and, more specifically and particularly to novel clear transparent, and/or part clear, part transparent inflatables of any and all sizes and types (such as balloons made out of latex, mylar balloons, and pvc inflatables) which are used generally for parties—all occasions, advertisements, and ornamentations, whereby, said inflatables are designed with Fluorescent and/or Phosphorescent paints/inks (Invisible or Visible, respectively), combined with electric and/or battery operated black ultra-violet light(s) and inflator nozzle fixture accessories, which are applied, attached, inserted and journaled into said inflatables, so as to create stupendous unique dramatic visual effects, whereby, the designed images (painted on said inflatables) shall appear and disappear before the (audience) viewers eyes.

### BRIEF DESCRIPTION OF THE PRIOR ART

Conventionally, the inflatables and electric light fixture industries are stagnant relative to producing advanced changes and innovations from the traditional use of these inflatables and light fixtures, and, limiting themselves to the ordinary use of standard inflatables paints and designs, and, large to small light fixtures, which always and continually perform the same function, which is just, to light up (illuminate) an object or area. U.S. Pat. No. 7,344,267, dated Mar. 18, 2008, Title: “Illuminated Toy Balloon” provides a valuable example, whereas it illustrates a standard balloon, which uses standard balloon paints, having an apparatus (inserted in the neck of said balloon) for illuminating the interior of said balloon. Said apparatus includes a cylindrical plug having a light element powered electrically by battery, and, having a switch to turn power (on/off), combined effectively with a patented inflator to inflate said balloon with air or helium gas, resulting in a still or flashing light within said balloon, by virtue of the battery powered light source. This invention is limited, in many respects. The light's illumination does not penetrate the exterior paint on said balloon giving viewers a poor quality, dim, low grade visual effect. The on/off switch is hidden underneath and adjacent to the electrical battery and light system, and, fitted inside the neck of said balloon, thereby, making it hard and inconvenient for users to turn said switch on/off when balloon is inflated. Said balloon with its patented inflator in said cylindrical plug can only be inflated using a sufficient strong source, like a very filled helium tank or an electric air pump. Said balloon cannot be inflated by mouth (as many children and adults like to do). The light system in said balloon's plug is limited to LED bulbs only, which may not be good enough to brighten-up an occasion. Thus, many of its features, as a whole, are inconvenient, unnecessary, time consuming by not being easily usable, and, uncomplimented by poor lighting effects. This prior art method, is only slightly satisfactory, and, the need for more compact, more diversified, easy usable methods having superb, dramatic, exciting visual effective results remain.

### SUMMARY OF THE INVENTION

Accordingly, the above problems and difficulties are obviated by the present invention which provides inflatables accessory items relating to improvements in means for designing the interior and/or exterior of said inflatables, and, attaching them to improved accessory light fixtures combined and provided with easy and simple to use inflator nozzles. At present, fluorescent inks and paints (clear, invisible, or visible), and, phosphorescent paints and inks, are solely used on t-shirts, street, highway and security markings, night clubs and ciscus special effects, presentations, in hidden messages, dual art work images, museums, painting your room, and so on. These paints/inks are used for outdoor and indoor applications. Because of the ingredient and substance “phosphor”—(any of a number of substances that exhibit luminescense when struck by light of certain wavelengths, as by ultra-violet), fluorescent paints/inks and phosphorescent paints/inks emit light, when exposed to real true black lights (or ultra-violet energy, as it is sometimes called), giving and creating brilliant lighting effects that amaze viewers. The real true black light bulb, or, an ultra-violet light bulb, when turned on, emits light at low energy, low frequency of 350-360 nm long wave ultra-violet light energy, which activates (turns on) fluorescent and phosphorescent paints/inks. Thus, true black lights, and/or, ultra-violet lights effect these paints/inks to the point, that designed images can be made to appear and disappear (in other words, bring out the hidden, and, obscure it again). Fluorescent paints/inks (clear, invisible and/or visible) are designated, herein the present invention, as, “fluorescent paint means”. Phosphorescent paints/inks, are designated herein the present invention, as, “phosphorescent paint means”. And, standard balloon paints, are designated herein the present invention, as, “standard paint means”. Visible fluorescent paints/inks and phosphorescent paints/inks (glow in the dark paints) can be seen in daylight and are affected by white lights and other color lights. Public domain inflators or inflator nozzles are presently, currently used to inflate toys, sports balls, balloons of large/huge advertisement/ornamental inflatables, car, truck and bicycle tires, air beds, camping sleepers, and so on, thereby, air, helium, or hydrogen gases are held in place, within these, by the temporary seating and sealing capacities of these inflators, to stop and prevent escape or leakage of air or gas. Some, of the most commonly used inflator nozzles are: the plug and stopper types, seen on beachballs, camping sleepers, air beds, which allow the users to fill by mouth, or a simple hand-air pump; the needle-injector types, seen in basketballs and footballs, which allow the users to fill using a simple hand-air pump, or helium filled tank; the needle, spring and and seat valve types, found in car, truck, bicycle tires, which allow users to fill, using a hand-air pump, or, a helium filled tank or, with an electric air pump; and, the reverse of the aforementioned plug and stopper, which are the seat and seal cap types, also seen in beachballs, air beds, and, which implements a resilient leaf or spring leaf attached to a sealing cap, whereby, coupled with the air or gas pressure inside the inflatables, sits and seals the cap on its respective seat, so as to prevent the escape or leaks of air or gas. Many, of the public domain inflators (of the same or similar functions of the ones just mentioned) can be used and adapted, and, are herein designated in the present invention, as, “inflator nozzle means”. Depending on how and in which inflatables a specific inflator nozzle means is used, will determine its usage. For example: All occasion balloons which are one-time use disposable items may use the inexpensive, simple and ease of use plug and stopper types (found in beachballs), while large, huge pvc advertisement/ornamental inflatables (balloons), should use a more durable expensive inflator nozzle means (spring, needle and seat valve types, found in car, truck, bicycle tires); The present invention also comprises an electric and/or battery operated black ultra-violet light(s) fixture accessory combined with aforementioned inflator nozzle means; Said electric and/or battery operated black ultra-violet light(s) fixture accessory comprises a support device made out of very light plastic, rubber, styrofoam, cardboard, and/or any other light material of definite length and width; Said width being of cylindrical, round or oval configuration and/or adaptable so as to be inserted, attached and journaled into the neck portion of said inflatables, and/or adatable to be suitably inserted into a specified portion/aperture of said inflatables; Said length and width being of sufficient size and dimention so as to have incorporated on and within said support device, one or more black ultra violet light bulbs connected to electric power source and/or battery operated power source, having switching means (on/off button, or, on/off sensor, etc.) to comprise the lighting means of said support device; Said electric and/or battery operated black ultra-violet light(s) fixture accessory (support device)further comprising a hole or aperture positioned adjacent to said incorporated electric and/or battery operated lighting means, and, which said hole or aperture extends from said support device's upper portion (adjacent to said black light bulbs), and, continuing lengthwise through the interior of said support device, in a downwards fashion, to the lower end portion of said support device, wherein said inflator nozzle means is inserted/attached/journaled and sealingly (adhesively) secured there-into said hole or aperture, so as to complete said electric and/or battery operated black ultra-violet Light(s) fixture accessories. The diversification of the present invention, by mixing and matching fluorescent paint means, to phosphorescent paint means, and to standard paint means, presents/provides numerous and multiple ways of designing images on said clear transparent and part clear/part transparent inflatables which, when connected and attached to said electric and/or battery operated black ultra-violet light(s) fixture accessories, shall give viewers extraordinary effects and forms of visual observational entertainments on every occasion, in advertisements, and, in ornamentations. This special, unique facet of the present invention accentuates many multiple uses about society complementing safetiness and freedom with ease of use for children and adults (having not to depend solely on oversized-heavy helium tanks, or, electric air pumps). Thus, it's the primary object of the present invention to provide, mixed and matched, fluorescent, and/or phosphorescent, and/or, standard designed painted clear transparent and/or part clear/part transparent inflatables connected to electric and/or battery operated black ultra-violet light(s) fixture accessories, which are combined with easy to use & apply inflator nozzle means, thereby, being safer, faster, easier to use, more versatile and compact comfortable for employment and transporting, emphasizing a higher marketability than its counterparts, by virtue of the exciting, dramatic, observational visual cause and effects of designs that appear and disappear right before the (audience) viewers eyes.

### BRIEF DESCRIPTION OF DRAWINGS

FIG. 1 is a perspective view of “Invisible And/Or Non-Invisible Designed Inflatables Combined With Electric Black Ultra Violet Lights And Inflator Nozzle Fixture Accessories” in accordance with the present invention;

FIG. 2 is a partial exploded perspective view of “Invisible And Or Non-Invisible Designed Inflatables Combined With Electric Black Ultra Violet Lights And Inflator Nozzle Fixture Accessories as seen in FIG. 1;

FIG. 3 is a partial cross sectional perspective view of the Electric (battery Operated) Black Ultra Violet Lights And Inflator Nozzle Fixture Accessories seen in FIGS. 1 and 2;

FIG. 4 is a bottom elevational view of the Electric (Battery Operated) Black Ultra Violet Lights And Inflator Nozzle Fixture Accessories seen in FIG. 3;

FIG. 5 is a bottom elevational view of a second embodiment of the Electric (Battery Operated) Black Ultra Violet Lights And Inflator Nozzle Fixture Accessories seen in FIG. 4;

FIG. 6 is a partial cross sectional view of a third embodiment of the Electric (Battery Operated) Black Ultra Violet Lights And Inflator Nozzle Fixture Accessories seen in FIGS. 1 through 5;

FIG. 7 is a partial cross sectional view of a fourth embodiment of the Electric (Battery Operated) Black Ultra Violet Lights And Inflator Nozzle Fixture Accessories seen in FIGS. 1 through 6, in accordance with the present invention;

FIG. 8 is a partial cross sectional view of a fifth embodiment of the Electric (Battery Operated) Black Ultra Violet Lights And Inflator Nozzle Fixture Accessories seen in FIGS. 1 through 6, in accordance with the present invention;

FIG. 9 is a partial cross sectional view of a sixth embodiment of the Electric (Battery Operated) Black Ultra Violet Lights And Inflator Nozzle Fixture Accessories seen in FIGS. 1 through 6, in accordance with the present invention;

FIG. 10 is a partial cross sectional view of a seventh embodiment of the Electric Black Ultra Violet Lights And Inflator Nozzle Fixture Accessories seen and described in FIGS. 1 through 9, in accordance with the present invention;

FIG. 11 is a perspective view of a second embodiment of “Invisible And/Or Non-Invisible Designed Inflatables Combined With Electric Black Ultra Violet Lights And Inflator Nozzle Fixture Accessories” seen and described in FIG. 1, in accordance with the present invention;

FIG. 12 is a perspective view of the Inflatables Divider membrane, in accordance with the present invention;

FIG. 13 is a perspective view of a third embodiment of “Invisible And/Or Non-Invisible Designed Inflatables Combined With Electric Black Ultra Violet Lights And Inflator Nozzle Fixture Accessories” employing the Inflatables Divider Membrane described and seen in FIG. 12, in accordance with the present invention;

FIG. 14 is a perspective view of a fourth embodiment of “Invisible And/Or Non-Invisible Designed Inflatables Combined With Electric Black Ultra Violet Lights And Inflator Nozzle Fixture Accessories” employing the Inflatables Divider Membrane described and seen in FIG. 12, in accordance with the present invention;

FIG. 15 is a perspective view of a fifth embodiment of “Invisible And/Or Non-Invisible Designed Inflatables Combined With Electric Black Ultra Violet Lights And Inflator Nozzle Fixture Accessories” seen and described in FIGS. 1, 6, 9, 10-14, in accordance with the present invention;

FIG. 16 is a perspective view of a sixth embodiment of “Invisible And/Or Non-Invisible Designed Inflatables Combined With Electric Black Ultra Violet Lights And Inflator Nozzle Fixture Accessories” seen and described in FIGS. 1-15, in accordance with the present invention;

FIG. 17 is a perspective view of a seventh embodiment of “Invisible And/Or Non-Invisible Designed Inflatables Combined With Electric Black Ultra Violet Lights And Inflator Nozzle Fixture Accessories” seen and described in FIGS. 1-16, in accordance with the present invention.

### DETAILED DESCRIPTION OF THE INVENTION

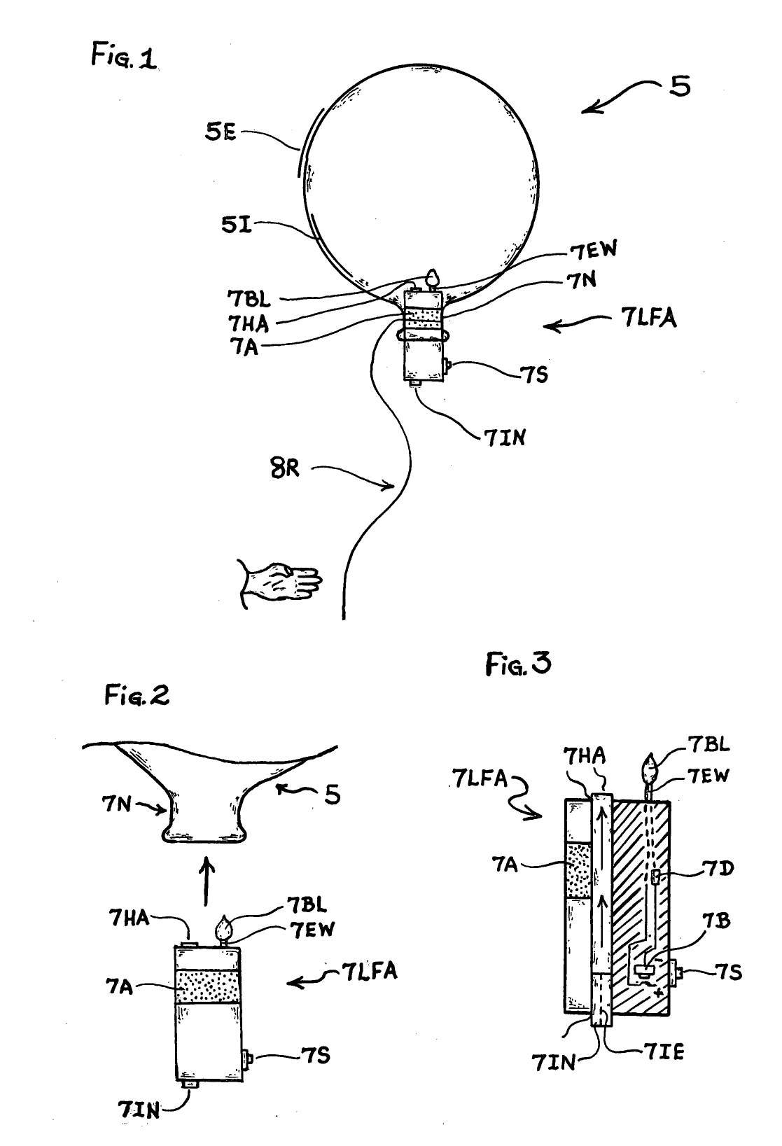

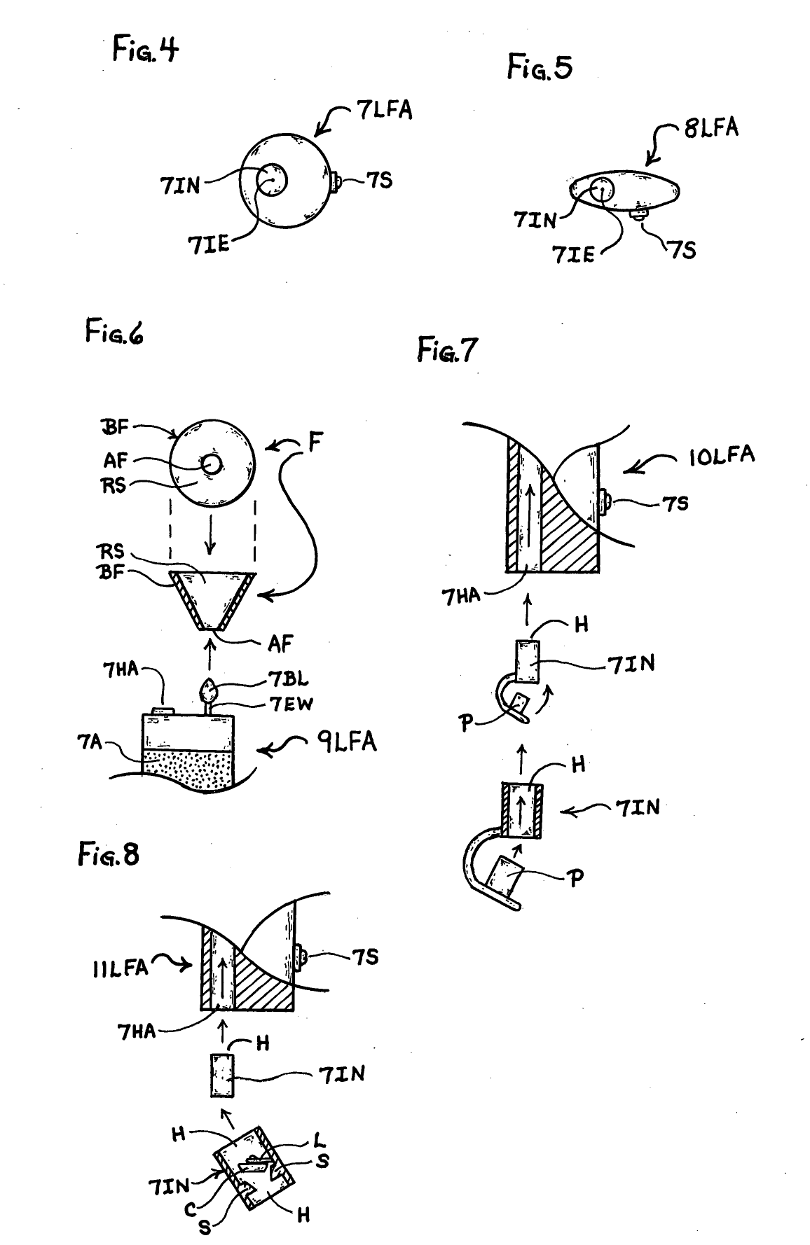

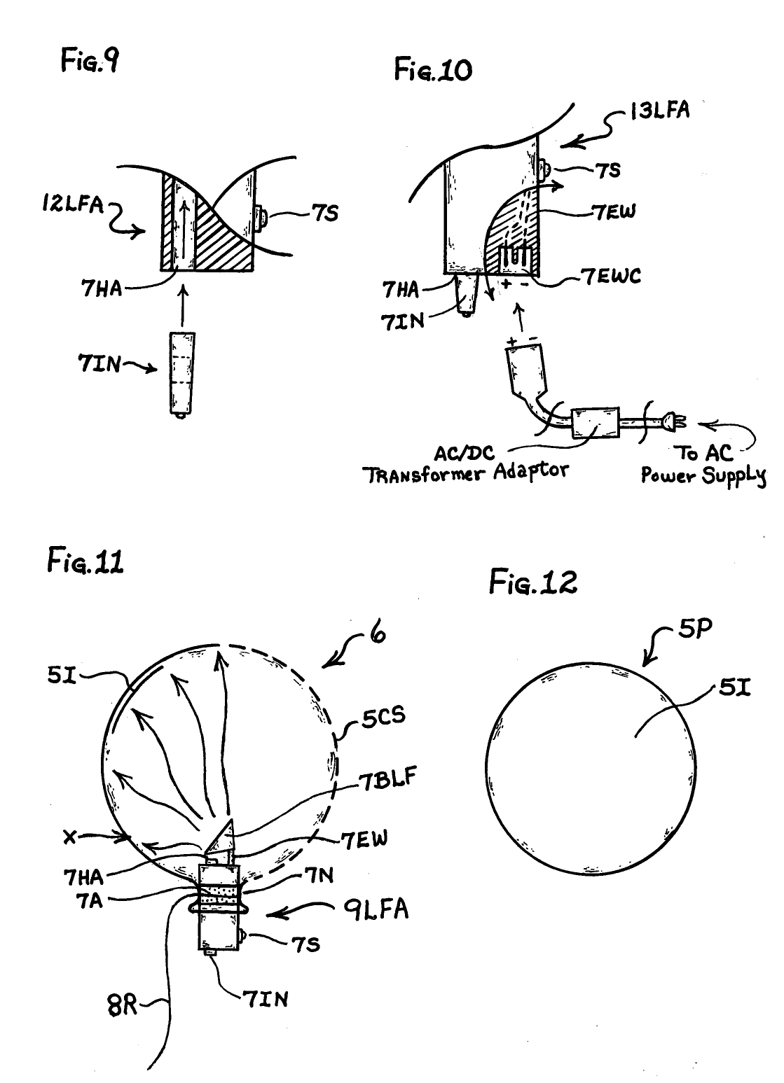

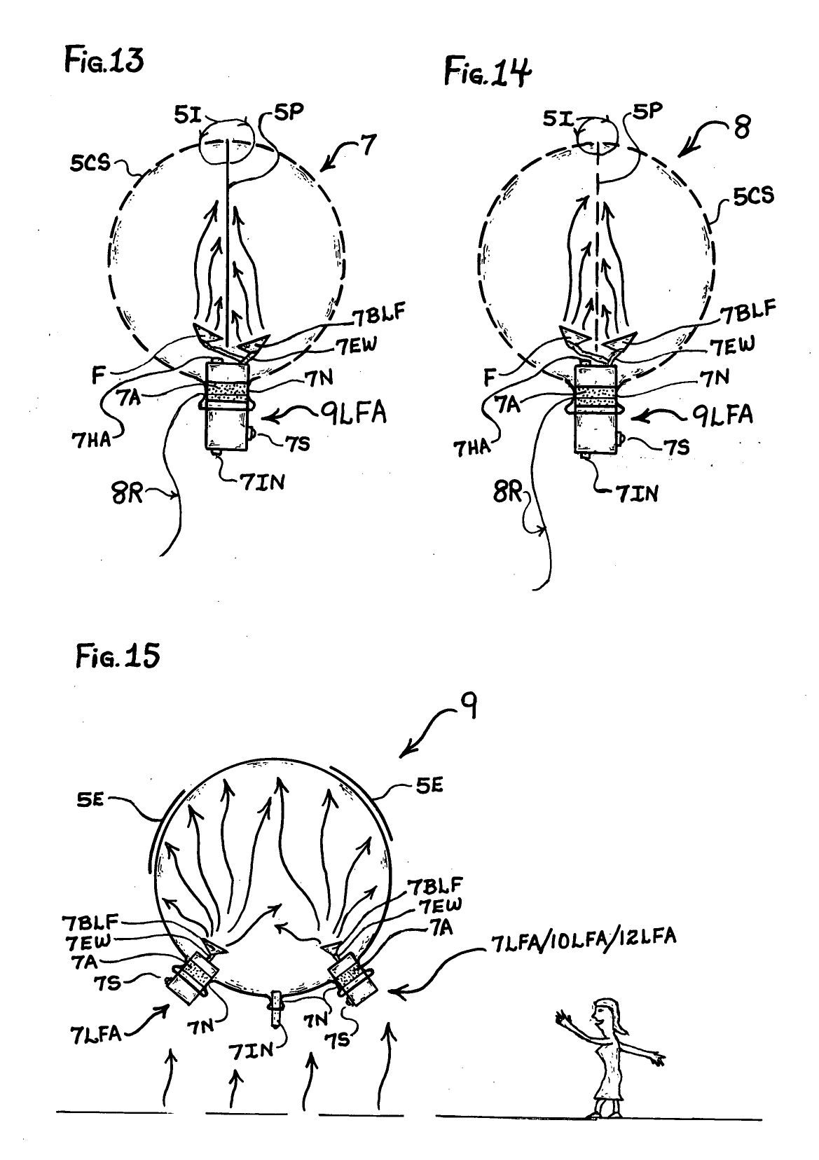

The preferred embodiments of the present invention will be explained with reference to FIGS. 1 through 17. There is seen in FIGS. 1, 2, 11, 13-17, seven embodiments of the “Invisible And/Or Non-Invisible Designed Inflatables”, generally designated 5 (FIGS. 1, 2) designated 6 (FIG. 11), and designated 7, 8, 9, 10, 11 for FIGS. 13, 14, 15, 16, 17, respectively. There is also seen in FIGS. 1 through 17, seven embodiments of the “Combined With Electric Black Ultra Violet Lights And Inflator Nozzle Fixture Accessories”, generally designated 7LFA (FIGS. 1-4), designated 8LFA (FIG. 5), designated 9LFA (FIG. 6), designated 10LFA (FIG. 7), designated 11LFA (FIG. 8), designated 12LFA (FIG. 9), and, designated 13LFA (FIG. 10).

FIG. 1 shows a perspective view of the combined said two first respective embodiments 5 and 7LFA showing and describing said electric (battery operated) black ultra violet lights and inflator nozzle fixture accessory 7LFA inserted into neck portion (herein designated 7N) of said inflatable 5, and, attached and secured thereto said 7N of said 5 by adhesive or securing means (herein designated 7A); Said 7LFA having a black light bulb (herein designated 7BL) which is connected to wiring/electronic means (herein designated 7EW); Said 7LFA also having a switch on/off button (herein designated 7S), a hole or aperture (herein designated 7HA), inflator nozzle means (herein designated 7I), and a ribbon or string (herein designated 8R) which said 8R further secures said 5 to said 7LFA.

Said inflatable 5 consists of a clear latex, mylar, pvc, nylon and/or any other materially made inflatable (clear balloon) having invisible and/or visible painted designs on the interior of said inflatable 5 (herein designated 5I), and/or having invisible and/or visible painted designs on the exterior of said inflatable 5 (herein designated 5E); Said inflatable 5 has a neck portion or a suitable entry aperture portion (designated 7N) into which said 7LFA is inserted, attached and adhesively secured thereto said 7N using adhesive/securing means 7A thereby preventing the escape and leaks of air, helium gas, or hydrogen gas; The importance of the Invisible painted designs and the Non-Invisible (Visible) painted designs on embodiment inflatable 5 (FIGS. 1 and 2) must be stressed and explained equally together with and along with the proceeding embodiments 6 (FIG. 11), and, embodiments 7, 8, 9, 10, and 11 (FIGS. 13, 14, 15, 16, 17 respectively), for said Invisible and/or Non-Invisible (Visible) painted designs are the “HALLMARK” of the present invention. As aforementioned, the Invisible and/or Non-Invisible (Visible) paints consist of fluorescent paint means, phosphorescent paint means and standard paint means, which can be mixed and matched to create and produce on the exterior and/or interior of said inflatables, unique, dramatic, multiple stupendous visual displays and effects emanating from said inflatables by using uncovered open and/or reflector flange directed black ultra violet light(s) and lighting means herein designated 7BL (FIGS. 1, 2, and 3), and, designated 7BLF (FIGS. 6, 11, 13-17) respectively; Therefore, said inflatables can be exteriorly designed only (designated 5E), or, said inflatables can be interiorly designed only (designated 5I), or, said inflatables can be interiorly designed 5I and exteriorly designed 5E in concert. Said interior designs 5I can display a soft exhuberance to visual perception, while said exterior designs 5E can promote a more vibrant appeal to the visual senses of the viewers. And, by combining both interior 5I and exterior 5E painted designs in concert (at the same time on one said inflatable), viewers will experience both and all phases of soft and vibrant colors consecutively and simultaneously in lavish ravish stupendous colorful exhibited displays of epic proportions. Thus, a said clear inflatable will look perfectly clear, when desined painted with Invisible fluorescent paint means and when said black light(s) 7BL/7BLF are turned ON, the designed painted images will appear before the viewers' eyes; And, when said 7BL/7BLF turns OFF, said designed painted images will disappear before the viewers' eyes. The hidden will become manifest and go back to obscurity. Plus, when mixing and matching said Invisible fluorescent paint means with Visible fluorescent paint means and/or with phosphorescent paint means, and/or with standard paint means, there's even greater further enhancements of the dramatic effects and exhibited displays to be experienced visually, due to the effects produced by said black light(s) 7BL/7BLF on said designed painted pigments, whereby, the invisible will turn visible, and, the normally visible pigments will go from dull to brilliance together with changes in colors as the black light(s) turn on and off consecutively, thereby, showing off emanations of mixed arrays of diversified colors in designs and images.

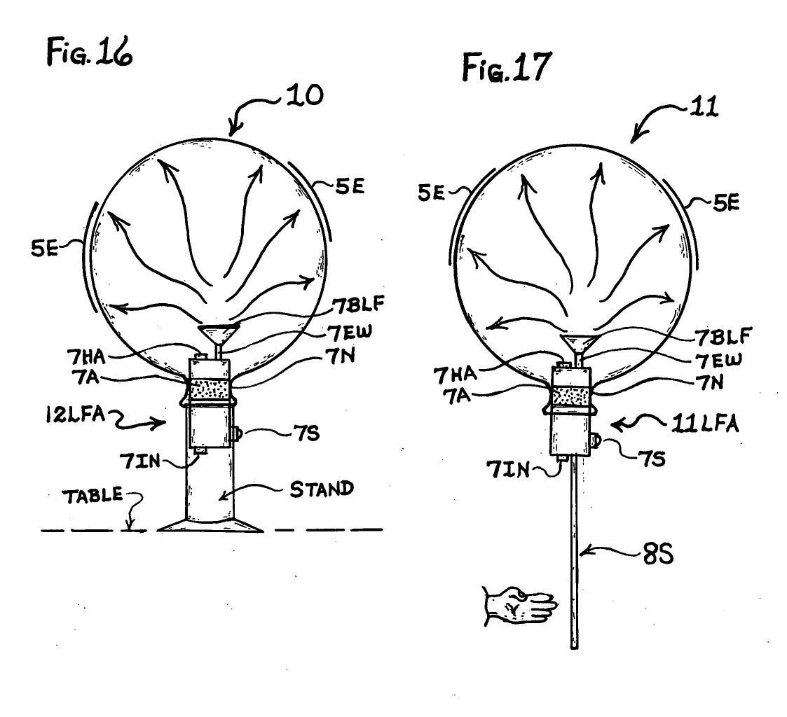

FIG. 2 is a partial exploded perspective view of the said inflatable 5 and said battery operated black ultra violet light(s) and inflator nozzle fixture accessory 7LFA seen and described in FIG. 1, whereby, there is seen embodiment 5 separated from 7LFA; Said 5 having said neck portion, or, a suitable entry aperture portion 7N; Said 7LFA having at its upper portion said hole/aperture 7HA and said black light bulb 7BL attached/connected to wiring/electronic means 7EW; Said 7LFA having an adhesive/securing band 7A (which 7A may be a two-sided adhesive tape); Said 7A circles and continues around the aforementioned cylindrical width of said 7LFA and suitably positioned so as to allow said 7LFA to be adhesively securely attached to said 7N, thereby permitting said on/off switch 7S to be easily accessible; Said 7S being a part of said 7LFA; Said 7S being a switching means; said 7LFA having at its lower end portion said inflator nozzle means 7I securely journaled and attached to said 7LFA; As aforementioned said 7LFA comprises said support device of the present invention. FIG. 3 is a partial cross sectional view of said 7LFA seen and described in FIGS. 1 and 2, herein further describing and demonstrating the exterior and interior workings of said electric (battery operated) black ultra violet lights and inflator nozzle fixture accessory/said support device 7LFA; As aforementioned said 7LFA is of suitable length and width; Said width of said 7LFA being of cylindrical round configuration; Said length and width of said 7LFA being of sufficient suitable size and dimention, hereby, showing sectional views of its pertinent parts, whereby, there is seen said hole/aperture 7HA at the upper portion of said 7LFA; Said 7HA defines an interior space which progresses continuously lengthwise (in a downwards fashion) through the interior of said 7LFA to the lower end portion of said 7LFA, wherein, there is seen said inflator nozzle means 7IN (basketball/football type of inflator nozzle); Said 7IN is inserted, attached and journaled into said lower portion of said 7HA and said 7LFA, and secured there to said 7HA by adhesive/securing means; Said 7IN having a needle insert hole (herein designated 7IE) which progresses continuously lengthwise through the center of said 7IN from the lower portion of said 7IN to the upper portion of said 7IN (as seen), wherein a sports ball filler needle is inserted into and through said 7IE to fill said 5 with air or helium gas sent in upwards fashion lengthwise progressively in defined interior space of said hole/aperture 7HA and into interior space or cavity of said 5, thereby filling said 5; Said 7HA is positioned adjacent to said black lights bulb 7BL; Said 7LFA having a second defined interior space wherein there is housed and incorporated the lighting means of said support device 7LFA; In said upper portion of said 7LFA, there is seen said black lights bulb 7BL suitably connected to said electronic wiring means 7EW; Said 7EW is of sufficient length, which length progresses into and through a small opening (not designated) located at said upper portion of said 7LFA and said 7EW is affixed thereto said hole/aperture to prevent movement during motion; Said 7BL and said 7EW are suitably connected by positive and negative polarities and said 7EW by continuity of connectivity and of sufficient length is efficiently connected to battery, or batteries (herein designated 7B) and to on/off switch 7S, whereby, during use, said switch 7S completes and closes the circuit, thereby, sending battery (7B) power through said 7EW and turn ON said 7BL; Said 7EW may have any inline suitably connected capacitors, diodes, MCUs (micro-controllers), and/or ICs (inline chips for special purposes) to control lighting modes and changes like still, intermittent, alternating, flash, slow and/or fast phase, etc. (herein designated 7D) plus, a PCB (printed circuit board) may be used to connect all the components; Said battery (or batteries) 7B may be rigidly affixed and restained in place within said second defined interior space in said 7LFA by any suitable retaining/holding means such as a small battery compartment and/or any type of securing device means; Said black light(s) bulb 7BL (light emitting elements/diodes, as they are also called) may be LED bulbs, incandescent bulbs, fluorescent bulbs, krypton bulbs, self-contained bulbs (having their own power source), and any other types, styles and sizes of bulbs may be used plus, when said 7LFA uses more than one said 7BL, the second bulb may be white or any other colored light in combination; Said switching means 7S may be on/off slide button, touch sensor, slide tab, etc., thus concluding the lighting means combined with said inflator nozzle means 7IN to comprise said electric (battery operated) black ultra violet light(s) and inflator nozzle fixture accessory (support device) 7LFA; FIG. 4 shows the bottom elevational view of said lower end portion of said 7LFA seen in FIGS. 1, 2, 3, where is seen said width's cylindrical round configuration which inserts perfectly into the neck portions of latex and pvc inflatables, thereby making it easy to attach sealingly to said 7N of 5; Seen also are said 7IN, 7IE and 7S previously described in FIGS. 1, 2, 3; Said described 7HA, 7BL and the rest of the lighting means components are a constant; FIG. 5 shows the bottom elevational view of a second embodiment of said electric (battery operated) black ultra violet light(s) and inflator nozzle fixture accessories (herein designated 8LFA), where is seen the lower end portion of said 8LFA being of oval configuration which inserts perfectly into the neck portions 7N of mylar (two parts) inflatables and attaching sealingly thereto; Seen also are said 7IN, 7IE, and 7S previously described in FIGS. 1, 2, 3; Said described 7HA, 7BL, and the rest of the lighting means components are a constant; FIG. 6 shows a partial cross sectional view of a third embodiment of said electric (battery operated) black ultra violet light(s) and inflator nozzle fixture accessories seen in FIGS. 1-5 (herein designated 9LFA) where is seen the top view and side cross sectional view of the reflector flange (herein designated F); Said reflector flange F is similar to the reflector flanges used in flashlights which are primarily to direct a light beam or source to a specific place or target; Said F can be made out of very light plastic, light metal, or cardboard and/or other light materials having a funnel or cone shaped configuration beginning with an apex (small opening, hole or aperture, herein designated AF), which said apex AF (located at the lower end portion of said reflector flange F) tapers outwardly with definite length and flanges outwardly in round circular fashion to upper end portion (herein designated BF); Said 7BL and 7EW are inserted into said AF and secured thereto AF by adhesive/securing means; Said F having an interior reflective surface (herein designated RS) which can be chromed or aluminum foil, so as to concentrate, channel, focus and direct the light ilumination emanating from said 7BL; Seen, also in FIG. 6, on embodiment 9LFA, are said 7A, 7HA, 7BL and 7EW (which are connected to said F); Said 7IN, 7IE, 7S, and the rest of the lighting means components described in FIGS. 1 through 5, are a constant; FIG. 7 shows a partial cross sectional view of a fourth embodiment of said 7LFA, 8LFA and 9LFA seen and described in FIGS. 1-6 (herein designated 10LFA), wherein there is seen said 7HA and inflator nozzle means 7IN (which is a beachball plug and stopper type) which comprises of a plug (herein designated P) which is firmly pressed into hole/aperture (herein designated H) thereby preventing escapes/leaks of air or helium gas, providing an efficient seal; Said P is attached to the exterior of said 7IN by a small resilient band thereby forming a one piece unit; Said 7IN is inserted/attached and journaled into said 7HA and affixedly secured by adhesive securing means; Also seen on said 10LFA is said 7S seen and described in FIGS. 1-6; Said 7A, 7HA F, 7BL, 7EW, and the rest of the lighting means components, seen and described in FIGS. 1-6, are a constant; FIG. 8 shows a partial cross sectional view of a fifth embodiment of said 7LFA, 8LFA, 9LFA and 10LFA seen & described in FIGS. 1-7 (herein designated 11LFA), wherein there is seen said 7HA and inflator nozzle means 7IN (herein being a second beachball type) which comprises of a tiny cylinder having interiorly positioned beveled cap (herein designated C), and interiorly positioned beveled seat (herein designated S said cylinder also having an interior defined space, hole/aperture (herein designated also H-like the first beachball plug stopper seen and described in FIG. 7) thereby serving the same purpose; said cap C is attached to a leaf spring (herein designated L) which is suitably secured to the interior wall of said 71N, thereby making said C resilient enough to seat sealingly on said S to prevent escapes/leaks of air or helium gas; Said second beachball type 7IN is inserted/attached and journaled into said 7HA and secured there into said 7HA by adhesive securing means; Also seen on said 11LFA is said 7S seen and described in FIGS. 1-7; Said 7A, 7HA, F, 7BL 7EW, and, the rest of the lighting means components, seen and described in FIGS. 1-7, are a constant; FIG. 9 shows a partial cross sectional view of a sixth embodiment of said 7LFA, 8LFA, 9LFA, 10LFA, and 11LFA seen and decribed in FIGS. 1-8 (herein designated 12LFA) wherein there is seen said 7HA and inflator nozzle means 7IN (herein being of spring, needle and seat valve commonly used in car, truck and bicycle tires and tubes); The interior working mechanism of this said 12LFA is not shown, because it is a very common inflator and widely used and sold in the market, and, thereby a part of this invention as means; Like the previously seen and described inflator nozzles, said 12LFA is also inserted/Attached and journaled into said 7HA and secured there into said 7HA by adhesive and securing means; Also seen on said 12LFA, is said 7S seen and described in FIGS. 1-8; Said 7A, 7HA, F, 7BL, 7EW, and, the rest of the lighting means components, seen and described in FIGS. 1-8, are a constant; FIG. 10 shows a partial cross sectional view of a seventh embodiment of said 7LFA, 8LFA, 9LFA, 10LFA, 11LFA, and 12LFA, seen and described in FIGS. 1-9 (herein designated 13LFA), wherein, there is seen in the bottom left lower end portion of said 13LFA said electronic wiring means 7EW suitably connected to an electronic wiring connector(herein designated 7EWC) having positive and negative polarities and being in continuity of connectivity by a pair of keyed prongs which are suitably connected to said 7EW; Said 7EWC, as mentioned) consists of having two prongs, so as to allow a suitable AC/DC transformer adaptor to connect there into said 7EWC; The said keyed aspect of said 7EWC is commonly known in the market, and needs not be designated; Said 7EWC and said 7EW may be suitably connected to said lighting means to either charge said batteries 7B, and/or connected straight to said 7S and 7BL, depending on whether said 7BL is an AC bulb or a DC bulb; Thus, said 13LFA may be an electronic AC (alternating current) black ultra violet light(s) and inflator nozzle fixture accessory, using strictly and only AC current, or, said 13LFA may be an electric (battery operated) black ultra violet light(s) and inflator nozzle fixture accessory, which uses an AC/DC power transformer adaptor to charge internal batteries 7B in said 13LFA (as shown); Seen also on said 13LFA is said 7IN (seen and described in FIG. 9) inserted/attached and journaled there into said 7HA (as shown); Seen, also is said 7S, which is suitably connected to said 7EW and said 7EWC; Accordingly, said 7HA located at the upper end portion of all aforementioned embodiments 7LFA through 13LFA, is a consstant, and, with respect to the above mentioned AC/DC on and in said 13LFA, said 7A, 7BL, 7EW, F, and, the rest of the lighting means components, seen and described in FIGS. 1-9, are a constant herein; As aforementioned, the importance of the Invisible painted designs plus the Non-Invisible (Visible) painted designs on said inflatables embodiments 5 (FIGS. 1 and 2), 6 (FIG. 11), and embodiments 7, 8, 9, 10, and 11 in FIGS. 13, 14, 15, 16, and 17 respectively, must be equally stressed, explained, and described herein, for these are “HALLMARK”, consisting and comprising fluorescent paint means, phosphorescent paint means, and, standard paint means, which can be mixed and matched to create and produce (on the interior and/or exterior of said inflatables) unique, dramatic, multiple stupendous visual displays and effects, emanating from said inflatables, caused by virtue of said uncovered open, or, reflector flange (F) directed black ultra violet light(s), to fashionably effect, alter, and change the usual, customary visual appearances and use of ordinary inflatables; Thus, FIG. 11 shows a perspective view of embodiment 6, wherein, there is seen a part clear/part transparent inflatable (clear protion of 6 is shown by the broken lines), whereby, said clear portion of 6 is see-through clear having absolutely no painted printed designs whatsoever, and, the unclear portion of 6 (herein designated X) having (on its interior surface)painted designs/images using fluorescent paint means (Invisible or Visible) alone, or, phosphorescent paint means, alone, and/or mixed and matched in suitable combinations, and, this said 6 is combined with said 9LFA having 7BL with F (combinely designated herein as 7BLF), said 7BLF being the cause to direct and focus the black light reflected ilumination on said painted designed images on said unclear portion X of said 6, to effect dramatically said designed painted images to make them appear and disappear in whole or in part, before the viewers (audience) eyes; As aforementioned, each and every electric (battery operated) black ultra violet light(s) and inflator nozzle fixture accessories embodiments, may have one or more black lights, or, black lights (bulbs) combined with other colored lights, like white lights; Therefore, by applying a double light system, said 9LFA can comprise one black light 7BLF, and one white light in a second F, and, when collaborated with said X in said 6, whereby, said X comprises the applications of mixed and matched fluorescent paint means (Invisible and Visible), with phosphorescent paint means, and, standard paint means, in carefully, strategically, articulately positioned painted designed images in combinations, and, also using and applying Invisible fluorecent painted designed images to cover over the Visible designed painted images, this consert will create and produce to demonstrate, two distinctively desined images in one plane; Thus, when the said double lights system in said 9LFA turn on/off, in consecutive order, said white light in F will effect and iluminate the said standard paint means and said phosphorescent paint means, and said black light 7BLF will effect and iluminate the Visible fluorescent painted designs, and, moreover, the Invisible painted designed images, which cover over all said Visible designed painted images, will truly be reactive by making the Visible phosphorescent paint means, and, standard paint means and, a portion of the Visible fluorescent painted designs, DISAPPEAR, before the viewers (audience) eyes, which is demonstrable, whereby, as one set of Visible painted designs appear, by virtue of the white light, and, same shall disappear, by virtue of the black light's effect on the Invisible painted designs, by, bringing out the HIDDEN (Invisible painted images) to the FOREFRONT-appearing, from the HIDDEN to VISUAL VISIBILITY, and, what was/is VISIBLE to OBSCURITY, continually on and on, as said double lights system consecutively turns on and off, thus, becoming a powerful, effective lighting tool, in the process; Seen also, in FIG. 11, are said 7EW, 7N, 7HA, 7A, 7S, 7IN, and 8R (as seen and described In FIGS. 1 and 2) which are constants herein; FIG. 12 shows a perspective view of the Inflatables Divider Membrane (herein designated 5P) which comprises of a very light, thin, clear round see-through plastic material which can be made out of latex, pvc, mylar, nylon, and/or any other clear transparent materials; The roundness of said 5P also depicts other shapes, as well, depending on usage; Said 5P consists of a two-sided divider membrane of see-through material, whereby, each side may be designed painted (herein designated 5I) with fluorescent paint means (Invisible and/or Visible), and/or with phosphorescent paint means, and/or with standard paint means, plus, also, each side of said 5P may have a totally different painted design 5I, than the other side, thus, culminating in a two-sided designed inflatables divider membrane 5P; Normally said 5P divides the two parts of a mylar (two-part) inflatable, the reby forming and having two carefully, strategically, articulately, distinctively positioned designed painted images on a third plane which is centered in the middle of said two-parts of said inflatable (as seen in FIGS. 13 and 14); FIGS. 13 and 14, show perspective views of embodiments 7 and 8, which are two full clear/full transparent mylar (two-part) inflatables (the clear portions of said 7 and 8 are shown by the broken lines-herein designated 5CS), wherein, there is seen said centered positioned inflatables divider membrane 5P in each of 7 and 8 respectively having two distinctively designed sides 5I on each said 5P; In said 7, there is seen a Visible 5P depicting the use of mixed and matched Visible and Invisible paints in combinations, and, in said 8, there is seen an Invisible fluorescent painted designed 5P (a clear transparent 5P demonstrated by the broken lines depicting the use of Invisible fluorescent paints on both sides of said 5P; So, in effect, said 7 would be totally clear on both exterior sides 5CS, and, in addition showing a two-sided 5I designed painted interior 5P (by virtue of the Visible paints), and, said 8 would be totally clear on both exterior sides 5CS, and, in addition, showing a totally clear two-sided 5I invisibly designed painted interior 5P (by virtue of the Invisible fluorescent paints); And, when said 7 is collaborated with the double light system of said 9LFA (as seen and described in FIG. 11), white light in F, and, black light 7BLF, thereby, focusing the reflector flange directed lights on the said two-sided 5I designed painted images on said 5P, this combination will create and produce to demonstrate, two distinctively designed images positioned in opposite sides of a plane; Thus, a Non-Invisible Designed Inflatable (as, also seen and described in FIG. 1); And, when said 8 is collaborated with the double light system of said 9LFA (as seen and described in FIG. 11), having two (2) 7BLF, thereby focusing the reflector flange directed lights on the said two-sided 5I invisibly designed painted images on said 5P, this combination will create and produce the demonstrable effects of bringing out the HIDDEN to the FOREFRONT-appearing from the HIDDEN to the VISIBLE and back to OBSCURITY-disappearing, continually on and on, as said double lights system consecutively and/or simultaneously turn on and off on two distinctively invisibly designed images positioned on opposite sides of a plane; Thus, an Invisible Designed Inflatable (as seen and described, also, in FIG. 1);

Seen, also, In FIGS. 13 and 14 are 7EW, 7A, 7N, 7S, 7IN, and 8R (as seen and described in FIGS. 1 and 2) which are constants herein; FIG. 15 shows a perspective view of embodiment 9 (a large/giant pvc inflatables which are commonly used in/for advertisements, and or, lighting, and/or ornamentations) wherein, here is seen said 9 hovering over the ground (air-bound) employing two (2) separate said 7LFA, and/or, 12LFA, and/or, 10LFA; Said 9 may be an Invisible designed inflatable, or, a Non-Invisible designed inflatable, or, a combination of both, and, said 9 may, also, be made out of latex, mylar, nylon, and/or any other light clear materials; Said 9 (herein) having exterior painted designs 5E, which painted exterior designs 5E are bathed and flooded by a pair/two (2) interiorly positioned and journaled said 7LFA/12LFA/10LFA having 7BLFs (each one, as shown) to direct and focus black light beams and iluminations effectively; Said 7LFA/12LFA/10LFA, each one respectively, may have more than one 7BLF, or, one 7BLF added to one white light in F (the double light system, seen and described in FIG. 11), and same may be straight AC (alternating current), and/or DC (direct current) battery operated (as seen and described in FIG. 10) employing and using a suitable AC/DC transformer adaptor, and/or an AC wiring means for connectivity; Moreover, said 7LFA/12LFA/19LFA are shown separate from their respective 7INs (as shown), thus, all inclusive electric (battery operated) black ultra violet light(s) and inflator nozzle fixture accessories may be deployed, used and made, with and without said inflator nozzle means 7IN;

Seen, also, in FIG. 15 are 7EW, 7A, 7N, 7S, and 7IN (seen and described in FIGS. 1-10) which are a constant herein;

FIG. 16 shows a perspective view of embodiment 10 (a pvc, latex, mylar inflatables which are rarely commonly used for lighting and/or ornamentations) herein shown and seen combined with said 12LFA whereby, said 10 is mounted on a support stand and held thereto said stand by securing means, thus, as shown, said 12LFA is inserted into, which may be a cylindrical or oval tube like structure of said stand, and, securely affixed thereto, so as to allow the user to easily access said 7S, and/or remove said 10 from said support stand for inflating said inflatable through said 7IN; Said user may place said 10 on a home or office table, for ornamentations; Said 12LFA may be AC or DC (as seen and described in FIG. 15) for suitable electrical power connectivity; Said 10 may be an Invisible designed inflatable, or, Non-Invisible designed inflatable, or, a combination of both, said 10 having exterior painted designs 5E which are bathed & flooded by said 7BLF on said 12LFA, to direct and focus black light beams and iluminations effectively;

Seen, also, insaid 10 are, said 7A and 7N, seen and described in FIGS. 1 and 2; FIG. 17 shows a perspective view of embodiment 11 (a pvc, latex, or mylar inflatables commonly used for party, ornamentations, and which may be an Invisible designed inflatable, or, a Non-Invisible designed inflatable, or, a combination of both) herein combined with said 11LFA, whereby, said 11 is suitably and securely mounted to a support stick or stem (of definite length), so as to be hand-held (as shown, said stick or stem is herein designated 8S); Thus, 8S is attached thereto said 11 using any type of securing/attaching, and/or adhesive means; Said 11 having exterior painted designs 5E, which are bathed and flooded by said 7BLF on said 11LFA, to direct and focus black light beams and iluminations effectively; Said 11 may also have interior designs 5I, or a combination of both 5E and 5I for superb dramatic visual effects, plus, also employing the double lights system, seen and described in FIGS. 11 through 14, for even greater demonstrable visual effects; Also seen, in said 11, are 7EW, 7A, 7N, 7S, and 7IN, seen and described in FIGS. 1-9, which are a constant herein. In FIGS. 1 through 17 (as seen), appreciates that through the use of all the embodiments and their diversifications, a manufacturer can put together numerous types, styles and models of itemized inflatables of the present invention, by interchanging inflatable embodiments and light fixture accessory embodiments in so many multiple ways, and more importantly, exceed in making advanced changes and innovations relative to designed images on inflatables, and, provide superbly rich creations of stupendous, unique, never before seen dramatic visual displays and effects, by virtue of The Self Emitting Light Technology.

### OPERATION OF THE INVENTION

The present invention relates generally to fluorescent paints/inks, (Invisible and/or Visible), phosphorescent paints, standard balloon paints, air and helium/hydrogen filled inflatables, and, electric and/or battery operated light fixtures and inflator nozzles, which are now being used and adapted in a variety of ways, in sports, party goods and supplies, circuses, and fun amusement parks accessories. The present invention provides novel Invisible and/or Non-Invisible (Visible) designed inflatables, combined with electric (battery operated) black ultra violet light(s)/standard lights and inflator nozzle fixture accessory items, that produce and create unique, dramatic, exciting visual displays and effects by implementing “The Self Emitting Light Technology”, of cause and effect, through the use of fluorescent paint means (Invisible and Visible), phosphorescent paint means (Glow In The Dark Paints), and standard paint means, mixed and matched, and/or, in combinations (to also form Day Glow Paints), so as to, specifically, carefully, strategically, and, articulately design the interior and/or exterior surfaces (portions) of clear transparent inflatables, made of any elastic or inelastic materials like plastics, latex, rubber, mylar, nylon, pvc, etc., etc., whereby, said designs on said exterior/interior surfaces of said clear transparent inflatables are literally and brilliantly turned “ON”, caused by the effects of said black ultra violet light(s) fixture accessories, which fixtures are combined/coupled with easy to use, common, everyday, inflator nozzle means, thereby, providing items of manufactures that will amaze viewers and audiences by causing the HIDDEN to APPEAR (to visual visibility), and, from what becomes MANIFEST back to OBSCURITY (invisible), by virtue of the continuous, on and off, off and on, consecutive/simultaneous light illumination effects on the invisible fluorescent, phosphorescent paint means, produced by the lighting means system (effective lighting tool, seen and described in FIG. 11, 13, 14) in said black ultra violet light(s) fixture accessories. The itemized inflatables and their electric (battery operated) black ultra violet light(s) and inflator nozzle fixture accessories can come totally separate one from the other, whereby, the user inserts said light fixture accessories into the neck portion and/or suitable entry aperture/hole portion 7N of said itemized designed inflatables (seen and described in FIG. 2), or, said items of manufactures can be bought in the forms of complete, compact comfortable, ready to use units, as seen and described in:

(a) FIG. 1—embodiment 5 combined with 7LFA and 8R;

(b) FIG. 11—embodiment 6 combined with 9LFA and 8R;

(c) FIG. 13—embodiment 7 combined with 9LFA and 8R;

(d) FIG. 14—embodiment 8 combined with 9LFA and 8R;

(e) FIG. 15—embodiment 9 combined with either and/or 7LFA/12LFA/10LFA;

(f) FIG. 16—embodiment 10 combined with 12LFA and stand;

(g) FIG. 17—embodiment 11 combined with 11LFA and 8S.

Depending on the usage of said itemized designed inflatables and/or said items of manufactures, and, with respect to said embodiments 5, 6, 7, 8, 9, 10, and 11, and, their respective said light(s) fixture accessories 7LFA (FIG. 1), 8LFA (FIG. 5), 9LFA (FIG. 6), 10LFA (FIG. 7), 11LFA (FIG. 8), 12LFA (FIG. 8), 12LFA (FIG. 9), and, 13LFA (FIG. 10), these said embodiments are interchangeable. Thus, said 7LFA in 5, may be reciprocal with 8LFA having an oval configuration, or, reciprocal with 9LFA having 7BL with reflector flange F, or, reciprocal with 10LFA having the beachball type inflator nozzle means, instead of the football type air insert needle inflator nozzle means found in 7LFA, or, reciprocal with 11LFA having the second type of beachball inflator nozzle means(sen and described in FIG. 8); And, in addition, said double light(s) system, seen and described for 9LFA (FIG. 13) can be deployed in said 7LFA, 8LFA 10LFA and 11LFA respectively, always depending and taking into consideration on how specifically, carefully, strategically, and, articulately said 5E and/or 5I are designed to achieve an expected desired result in visual displays and effects. The same is apparent and true for embodiment 6 (FIG. 11), whereby, said double light(s) system may also be deployed herein, plus, said 9LFA may be reciprocal with 7LFA, 8LFA, 10LFA, and, 11LFA, thereby, using a different inflator nozzle means, and, said 6 may also comprise said double light(s) system or a single 7BL/7BLF, always depending and taking into consideration on how specifically, carefully, strategically, and, articulately said 5I in 6 is designed to achieve an expected desired result in visual displays and effects.

Embodiments 7 and 8 (FIGS. 13 and 14, respectively) comprise of the inflatables divider membrane 5P (which may be used in mylar two part inflatables—latex, pvc, etc. are also candidates); Said double light(s) system is and needs to be deployed herein, automatically thereby, focusing the reflector flange directed lights on said two sided 5I in 5P, thus, having and demonstrating two distinctively designed images positioned in opposite sides of a plane 5P, always depending and taking into consideration on how specifically, carefully, strategically, and, articulately both 5Is in 5P are designed to achieve an expected desired result in visual displays and effects. Said 9LFA in 7 and 8, may be reciprocal with 10LFA and 11LFA, thereby using different types of inflator nozzle means. Embodiment 9 (FIG. 15) comprises a large giant pvc inflatables, which are generally used for advertising, lighting, and, ornamentations, and, said 9 may also be made out of latex, mylar, nylon, etc., having 7LFA/12LFA/10LFA and said 7IN separate from each other, thus, said 7LFA/12LFA/10LFA herein 9 are not combined with said 7IN. Additionally 7LFA/12LFA/10LFA (each one individually) may have one or more 7BLFs, and/or, one or more uncovered open 7BLs, always depending and taking into consideration on how specifically, carefully, strategically, and, articulately said 5E in 9, is designed to achieve an expected desired result in visual displays and effects. Said 7IN (as herein used) is, of the more durable, stronger spring, needle, and, seat valves types of inflator nozzle means used and found in car, truck, and, bicycle tires and tubes, which, can withstand much more inner pressures of air, helium, or, hydrogen gas, over and above the simpler inflator nozzle means seen and described for said 7LFA, 8LFA, 9LFA, 10LFA, and, 11LFA, which are used for smaller inflatables, like balloons in party settings. Said 7LFA/12LFA/10LFA may be reciprocal with 8LFA, 9LFA, 11LFA, and, 13LFA, provided the latter are not combined with 7IN, as the former, Depending on the size of said inflatables, said 9 may comprise of more than two entry ports 7N, thus, a multiple series of said 12LFA may be used to flood light and illuminate much more interior space and area, and, plus, said 12LFA is already combined with said spring, needle, and seat valve type inflator nozzle means 7IN, said 12LFA may be reciprocal with 13LFA which may be connected to an AC outlet using AC/DC transformer adaptor to charge internal batteries 7B in said 13LFA, or, said 13LFA may be strictly AC powered fixture accessory, thereby, connecting same to an AC outlet; Additionally, said AC/DC transformer adaptor and/or said AC outlet connections to said 13LFA in said 9 can be modified to power a whole series and/or numerous 13LFA's via any manufactured suitable AC and/or DC multiple attachments conduits; Said 9 may also be interiorly designed 5I, or, carefully, strategically, and, articulately designed on both 5E and 5I, depending on the desired visual displays and effects to be achieved; FIGS. 16 and 17 show embodiments 10 and 11 respectively, said 10 having said 12LFA supported on a stand, which said 10 is an air-filled inflatable to be used as an ornament for home, office, etc., said 11 having said 11LFA supported by a securely attached stem, stick, straw, rod, or, tube-like elongated handle structure 8S so that said 11 may be hand-held (as are common, everyday, air-filled all occasion balloons), said 12LFA and said 11LFA (herein) are using the common, everyday, simple to use, easy to use inflator nozzle means 7IN (which are the basketball, football and/or beachball types) which allow the user to fill/inflate said 10 and/or 11, by mouth, or by using a simple hand air pump, said 12LFA of 10 may be reciprocal with said 13LFA so as to be AC/DC powered by transformer adaptor, or, strictly AC powered, thereby, connecting same to an AC outlet, said 10 and said 11 are exteriorly designed 5E using 7BLF to flood their interiors with lights illuminations, whereby, both 10 and 11 may also be interiorly designed 5I, or, carefully, strategically, and, articulately designed on both 5E and 5I, depending on the desired visual displays and effects to be achieved, Said embodiments 10 and 11 may also comprise of inflatables divider membrane 5P (FIG. 12) and use the said double lights system, seen and described in FIGS. 13 and 14, whereby, two distinctively designed images are positioned and displayed in opposite sides of a plane, Thus, as it can be seen, that through the applications of all the embodiments and their diversifications, the present invention has exceeded in making advanced changes and innovations relative to design images on inflatables by providing superbly rich creations of stupendous, unique, never before seen, dramatic visual displays and effects by virtue of The Self Emitting Light Technology.

Contemplating the construction of the itemized inflatables, and, their respective light fixture accessories of the present invention, the important point to remember, is that lightness and a degree of strength is of importance. Therefore, rubber, plastic, styrofoam, cardboard, and/or any other light materials can be used for the mold of the fixture accessories, not including the electric lighting means where the black light bulbs, the white light or any other colored bulbs may and can be LED, fluorescent, incandescent, xenon, halogen, krypton, miniature flood lights, laser light bulbs, or any other type of usable light bulbs insaid light fixture accessories; and rubber, plastic, latex, mylar, pvc, nylon, or, any other clear transparent light materials can be used for the itemized inflatables, and, it can be left up to the discretion of manufactures. OTHER RAMIFICATIONS OF THE PRESENT INVENTION does include, that, The Self Emitting Light Technology by the use of fluorescent paint means, phosphorescent paint means, and, black light uv lighting means does also apply to Clear Transparent Non-Inflatables (which directly mimic the Inflatables of the present invention in materials, size, shapes and forms), whereby, clear transparent balls, domes, spheres, and, flat dimentional surfaces (that do-not require inflation with air, helium, or, hydrogen gas) can be used for party events, advertising, lighting, ornamentations, and as all occasion cards, using the aforementioned means, as seen, described, and claimed in the present invention. And, in addition, SIMULATION TO STIMULATION can be employed, not only for and in the present invention, but also, for the said OTHER RAMIFICATIONS herein.

Simulation to Stimulation depicts, that the black light uv bulb can be Simulated by the combination of a red light bulb and a blue light bulb united together in the reflector flange (F) of the present invention, whereby, the combined lights and illuminations emitted by the red and blue light bulbs in said reflector flange (F) are converted into violet lights and illuminations which, to a good extent, provides Stimulation to fluorescent paints and phosphorescent paint means, much like, said black light uv bulb lighting means. While particular embodiments of the present invention have been shown and described, it will be obvious to those skilled in the art, that other changes in form and detail and/or rami-fications may be made without departing from this invention in its broader aspects and, therefore, the aim in the appended claims is to cover all such changes and modifications as fall within the true spirit and scope of this invention.

What is claimed is:

1) An invisible designed inflatable combined with electric (battery operated) black ultra violet light(s) and inflator nozzle fixture accessory, the combination comprising:
a clear transparent elastic and/or inelastic inflatable made of diversified materials of any suitable sufficient size, shapes and forms having an exterior wall or surface and an interior wall or surface, said interior wall or surface and said exterior wall or surface defines a plane, said plane defining a hollow interior space of predetermined size, depth and length and having one entrance into said space, said space having a beginning at said entrance, said entrance comprises a neck portion, or, a suitable entry port into said space, and, said space having an end within said clear transparent inflatable, said exterior wall or surface of said plane comprises of painted and/or printed designs and/or images using fluorescent paint means of the Clear-Invisible spectrum, and/or, said interior wall or surface of said plane comprises of painted and/or printed designs and/or images using fluorescent paint means of the Clear-Invisible spectrum;
a support device which defines said electric (battery operated) black ultra violet light(s) and inflator nozzle fixture accessory being of definite length and width having an upper portion, a middle portion, and, a lower end portion, said width being of cylindrical round configuration, and/or, adaptable for integral insertion, accomodation, and, journaling into said neck portion, or, suitable entry port of said entrance of said clear transparent inflatable, said support device is securely and/or adhesively journaled thereinto said entrance and conjoined using any securing and/or adhesive means (two-sided tape) situated round about said middle cylindrical portion of said support device, said support device is further secured and supported at said entrance by a ribbon or string of definite length (5 or 6 feet in length) which is tied/secured to the exterior portion of said entrance (neck portion, or suitable entry port), thereby, said ribbon/string is used as holding agent to hold and locate said combination, said definite length and width of said support device being of sufficient size and dimention, thereby, defining a first and a second hollow interior spaces, said upper portion of said support device accomodates suitably one or more black ultra violet light bulb(s) exteriorly located and situated, whereby, said black ultra violet bulb(s) is/are suitably connected to electronic wiring means of sufficient length, said electronic wiring means progresses lengthwise (in a downwards fashion) into and through a small opening at the top of said upper portion, said small opening is of sufficient size for the insertion accomodation of said electronic wiring means which is affixed thereto said small opening by any adhesive/securing means to prevent movement during motion, said electronic wiring means then continuously progresses lengthwise from said small opening (in a downwards fashion) interiorly in said defined second hollow interior space and being of sufficient length is suitable and efficiently connected by positive and negative polarities and in continuity of connectivity to battery (batteries), switching means (on/off switch, button, sensor, etc,), inline suitably connected capacitors, diodes, micro-controllers (MCU's), inline chips (IC's) for special purposes to control lighting modes and changes, plus, a printed circuit board (PCB) may be used to connect all said components, which are interiorly secured in said second defined hollow interior space by any suitable retaining/holding means, said switching means is suitably connected (as aforementioned) in said second defined hollow interior space, but, the actual on/off switch, button, sensor, is located, situated and positioned on the exterior towards the lower end portion, just below the said middle portion (adhesive/securing means) of said support device; said upper portion has a second hole or aperture defining the first hollow interior space positioned adjacent to said black ultra violet light bulb(s), said second hole or aperture begins at said upper protion and progresses continuously lengthwise (in a downwards fashion) through the interior of said support device, to and through said lower end portion defining the continuum of said second hole or aperture from said upper portion to said lower end portion of said support device, said hole or aperture at said lower end portion receives the inflator nozzle means which is inserted, journaled, and secured thereto said hole or aperture using any adhesive/securing means, as holding agent;

2) An invisible designed inflatable combined with electric (battery operated) black ultra violet light(s) and inflator nozzle fixture accessory, the combination comprising;
a clear transparent elastic and/or inelastic inflatable made of diversified materials of any suitable sufficient size, shapes, and, forms having an exterior wall or surface, an interior wall or surface, and, an inflatable divider membrane concentrically positioned to said exterior wall or surface and to said interior wall or surface in said clear transparent inflatable, said exterior wall or surface and said interior wall or surface defines a first plane, said first plane defining a hollow interior space of predetermined size, depth, and length and having one entrance into said space, said space having a beginning at said entrance, said entrance comprises a neck portion, or, a suitable entry port into said space, and, said space having an end within said clear transparent inflatable, said inflatable divider membrane defines a secondary plane having two opposite sides or surfaces, said secondary plane is also made of clear thin transparent elastic and/or inelastic diversified materials of any suitable sufficient size, shapes, and, forms to fit suitably in said space, thereby, respectively providing a common concentric center in said hollow interior space of said clear transparent inflatable, said secondary plane comprises of carefully, strategically, and, articulately painted and/or printed designs and/or images using fluorescent paint means (of the Clear-Invisible spectrum), on each of said two opposite sides or surfaces, whereby, one side may have a distinctively different design/image than its opposing side on said secondary plane;
a support device which defines said electric (battery operated) black ultra violet light(s) and inflator nozzle fixture accessory being of definite length and width having an upper-portion, a middle portion, and, a lower end portion, said width being of cylindrical round configuration, and/or, adaptable for integral insertion, accomodation, and, journaling into said neck portion, or, suitable entry port of said entrance of said clear transparent inflatable, said support device is securely and/or adhesively journaled thereinto said entrance and conjoined using any securing and/or adhesive means (two-sided tape) situated round about said middle cylindrical portion of said support device, said support device is further secured and supported at said entrance by a ribbon or string of definite length (5 or 6 feet in length) which is tied/secured to the exterior portion of said entrance (neck portion, or suitable entry port), thereby, said ribbon/string is used as holding agent to hold and locate said combination, said definite length and width of said support device being of sufficient size and dimention, thereby, defining a first and a second hollow interior spaces, said upper portion of said support device accomodates suitably one black ultra violet light bulb, and, one white light bulb; exteriorly located and situated, whereby, boths said light bulbs are suitably connected to electronic wiring means of sufficient length, said electronic wiring means progresses lengthwise (in a downwards fashion) into and through a small opening at the top of said upper portion, said small opening is of sufficient size for the insertion accomodation of said electronic wiring means which is affixed thereto said small opening by any adhesive/securing means to prevent movement during motion, said electronic wiring means then continuously progresses lengthwise from said small opening (in a downwards fashion) interiorly in said defined second hollow interior space and being of sufficient length is suitable and efficiently connected by positive and negative polarities and in continuity of connectivity to battery (batteries), switching means (on/off switch, button, sensor, etc,), inline suitably connected capacitors, diodes, micro-controllers (MCU's), inline chips (IC's) for special purposes to control lighting modes and changes, plus, a printed circuit board (PCB) may be used to connect all said components, which are interiorly secured in said second defined hollow interior space by any suitable retaining/holding means, said switching means is suitably connected (as aforementioned) in said second defined hollow interior space, but, the actual on/off switch, button, sensor, is located, situated and positioned on the exterior towards the lower end portion, just below the said middle portion (adhesive/securing means) of said support device; said upper portion has a second hole or aperture defining the first hollow interior space positioned adjacent to said black ultra violet light bulb(s), said second hole or aperture begins at said upper protion and progresses continuously lengthwise (in a downwards fashion) through the interior of said support device, to and through said lower end portion defining the continuum of said second hole or aperture from said upper portion to said lower end portion of said support device, said hole or aperture at said lower end portion receives the inflator nozzle means which is inserted, journaled, and secured thereto said hole or aperture using any adhesive/securing means, as holding agent;

3) An invisible designed inflatable combined with electric (battery operated) black ultra violet light(s) and inflator nozzle fixture accessory, the combination comprising:
a clear transparent elastic and/or inelastic inflatable made of diversified materials of any suitable sufficient size, shapes, and, forms having an exterior wall or surface and an interior wall or surface, said exterior wall or surface and said interior wall or surface defines a plane, said plane defines a hollow interior space of predetermined size, depth, and, length and having one or more entrances into said space, said space having one or more beginnings at said one or more entrances into said space, whereby, each of said entrances, respectively, comprises a neck portion, or, a suitable entry port into said space, and, said space having an end within said clear transparent inflatable, said exterior wall or surface of said plane comprises of painted and/or printed designs and/or images using fluorescent paint means of the Invisible-Clear spectrum, and/or, said interior wall or surface comprises of painted and/or printed designs and/or images using fluorescent paint means of the Clear-Invisible spectrum;
a support device which defines said electric (battery operated) black ultra violet light(s) fixture accessory having said inflator nozzle means as a separate item disengaged from said light fixture accessory, wherein, being of definite length and width having an upper portion, a middle portion, and, a lower end portion, said width being of cylindrical round configuration, and/or, adaptable for integral insertion, accomodation, and, journaling into said neck portion, or, suitable entry port of suitable said entrances of said clear transparent inflatable, said support device is securely and/or adhesively journaled thereinto said suitable entrance(s) and conjoined using any securing and/or adhesive means (two-sided tape) situated round about said middle cylindrical portion of said support device, said support device is further secured and supported at said entrance(s) by any type of ribbon, string, or, tie of definite length, which is tied/secured to the exterior portion of said entrance(s) neck portion, or, suitable entry port, as holding agent on said combination, said definite length and width of said support device being of sufficient size and dimention, thereby, having a defined hollow interior space, said upper portion of said support device accomodates suitably, one or more black ultra violet light bulbs, which, in turn, may be combined accomodatingly with one, or, more white light bulbs (or of any other colors-excluding black lights), exteriorly located and situated on said upper portion, whereby, all said light bulbs are suitable attached, connected, and/or threaded into respective suitable electronic wiring means having same respective suitable connections, said electronic wiring means and their respective suitable respective connections are of sufficient tact and length which progresses lengthwise (in a downwards fashion) into and through a hole/aperture, or opening at the top of said upper portion, said hole/aperture or opening is of sufficient size and dimention to accomodate securely any type of respective suitable connections to match any type of suitable respective attachments, connections, and/or threaded portions of said light bulbs, whereby, said suitable connections, attachments and or threaded portions are affixed thereto said hole/aperture, or, opening by any adhesive/securing means to prevent movement during motion, said electronic wiring means then continuously progresses lengthwise from said hole/aperture, or, opening (in a downwards fashion) interiorly in said hollow interior space, and, being of sufficient length, is suitably and efficiently connected by positive and negative polarities and in continuity of connectivity to ______, a set of batteries (or battery), and, switching means (on/off switch, button or sensor, etc.), and to electronic wiring connector having external means located at said lower end portion for connecting to a suitable AC/DC transformer adaptor, said interiorly located electronic wiring means having inline suitably connected capacitors, doides, micro-controllers (MCUs), inline chips (ICs) for special purposes to control lighting modes and changes, plus a printed circuit board (PCB) may be used to connect all said components, which are interiorly secured in said hollow interior space by any suitable retaining/holding means, said switching means is interiorly connected to said electronic wiring means (as aforementioned), in said hollow interior space, but, the actual on/off switch, button, or sensor, is located, situated, and, positioned on the exterior towards the lower end portion, just below the said middle portion (adhesive/securing means) of said support device, said suitable transformer adaptor charges the internal battery (batteries) in said support device, when connected to suitable AC outlet, said inflator nozzle means is adaptable to be securely/adhesively inserted/journaled into any suitable entrance in said clear transparent inflatable;

4) An invisible designed inflatable combined with electric (battery operated) black ultra violet light(s) and inflator nozzle fixture accessory, as set forth in claims 1 and 3, wherein;
a) said painted and/or printed designs and/or images using fluorescent paint means of the Clear-Invisible spectrum on said exterior wall or surface, and/or, on said interior wall or surface, may be substituted for painted and/or printed designs and/or images using fluorescent paint means of the Visible spectrum, and/or, may be sub-stituted for phosphorescent paint means (Glow in the Dark paints-Visible spectrum), and/or, may be substituted for standard paint means (Visible spectrum), whereby, also, all or part of the said paint means of the Visible spectrum may be suitably mixed and matched (to form Day Glow paints), and/or combined in carefully, strategically, and, articulately design images to comprise produce the Non-Invisible designed inflatable combined with electric (battery operated) black ultra violet light(s) and inflator nozzle fixture accessory having The Self Emitting Light Technology;
b) said painted and/or printed designs and/or images using fluorescent paint means of the Clear-Invisible spectrum on said exterior wall or surface, and/or, on said interior wall or surface, may be carefully, strategically, and, articulately combined with fluorescent paint means of the Visible spectrum, and/or combined with phosphorescent paint means (Glow in the Dark paints-Visible spectrum), and/or combined with standard paint means (Visible spectrum), whereby, also, all or part of the paint means of the Visible spectrum may be suitably mixed and matched(to form Day Glow paints), or, all said paint means of both the Invisible and Visible spectrums may be specifically combined in such position design images, to produce and comprise the invisible and non-invisible designed inflatable combined with electric (battery operated) black ultra violet light(s) and inflator nozzle fixture accessory, having The Self Emitting Light Technology, always taking into consideration, that, the Clear-Invisible spectrums are to take precedence over the Visible spectrums, so as to display the fascinating effects of the HIDDEN to Visual Visibility, and from the Visible, back to OBSCURITY;

5) An invisible designed inflatable combined with electric (battery operated) black ultra violet light(s) and inflator nozzle fixture accessory, as set forth in claim 2, wherein:
a) said painted, and/or, printed designs, and/or, images using fluorescent paint means of the Clear-Invisible spectrum on each of the said two opposite sides or surfaces of said inflatables divider membrane/secondary plane may be substituted for painted and/or printed designs and/or images using fluorescent paint means of the Visible spectrum, and/or, may be substituted for phosphorescent paint means (Glow in the Dark paints-Visible spectrum), and/or, may be substituted for standard paint means (Visible spectrum), whereby, also, all or part of the said paint means of the Visible spectrum may be suitably mixed and matched (to form Day Glow Paints), and/or, combined in carefully, strategically, and, articulately design images to comprise and produce the non-invisible designed inflatable combined with electric (battery operated) black ultra violet light(s) and inflator nozzle fixture accessory having and using The Self Emitting Light Technology, thereby, creating to demonstrate two distinctively designed images positioned in opposite sides of said secondary plane;
b) said painted, and/or, printed designs, and/or, images using fluorescent paint means of the Clear-Invisible spectrum on each of the said two opposite sides or surfaces of said inflatables divider membrane/secondary plane may be carefully, strategically, and, articulately combined with fluorescent paint means of the Visible spectrum, and/or combined with phosphorescent paint means (Glow in the Dark paints-Visible spectrum), and/or combined with standard paint means (Visible spectrum), whereby, also, all or part of the paint means of the Visible spectrum may be suitably mixed and matched (to form Day Glow paints), or, all said paint means of both the Invisible and Visible spectrums may be so specifically combined in such position designed images, to produce to comprise the invisible and non-invisible designed inflatable combined with electric (battery operated) black ultra violet light(s) and inflator nozzle fixture accessory, having and using The Self Emitting Light Technology, thereby, creating to demonstrate two distinctively designed images positioned on opposite sides of said secondary plane, and, always taking into consideration that, the Clear-Invisible spectrums are to take precedence over the Visible spectrums, so as to display the fascinating effects of the HIDDEN to Visual Visibility, and from the Visible, back to OBSCURITY;

6) An invisible designed inflatable combined with electric (battery operated) black ultra violet light(s) and inflator nozzle fixture accessory, as set forth in claim 3, wherein the additional usable methods are:
a) said support device comprises no internal batteries (battery), strictly having internal and external alternating current (AC) suitable connectivity, thereby, using AC bulbs to match, for connecting same to an AC outlet via said electronic wiring connector at said lower end portion of said support device;
b) said combination further comprises a stand means, and secured thereto said stand means using any attaching/securing means which allows the user to separate combination from said stand, said combination and stand are for ornamental use, thereby, setting same on a home or office table desk;

7) An invisible and/or non-invisible designed inflatable combined with electric (battery operated) black ultra violet light(s) and inflator nozzle fixture accessories, as set forth in any one of claims 1, 2, 3, 4, 5, and, 6, wherein, said support device's width is of oval shaped configuration;

8) An invisible and/or non-invisible designed inflatable combined with electric (battery operated) black ultra violet light(s) and inflator nozzle fixture accessories, as set forth in any one of claims 1, 2, 3, 4, 5, 6, and, 7, wherein, said support device further comprises a securely attached stem/stick/or straw-like tube means selectively used to hold and locate said combinations in party settings and all occasional events;

9) An invisible and/or non-invisible designed inflatable combined with electric (battery operated) black ultra violet light(s) and inflator nozzle fixture accessories, as set forth in any one of claims 1, 2, 3, 4, 5, 6, 7, and, 8, wherein, (where applicable), the usable methods are:
a) said inflator nozzle means on said support device comprises of a sports air needle (football or basketball) type of inflator nozzle;
b) said inflator nozzle means on said support device comprises of a plug and stopper (beachball) type of inflator nozzle;
c) said inflator nozzle means on said support device comprises of a beveled leaf spring cap and beveled seat (beachball) type of inflator nozzle;
d) said inflator nozzle means on said support device comprises of the spring, needle and seat valve (automobile and bicycle) type of inflator nozzle;

10) An invisible and/or non-invisible designed inflatable combined with electric (battery operated) black ultra violet light(s) and inflator nozzle fixture accessories, as set forth in any one of claims 1, 2, 3, 4, 5, 6, 7, 8, and, 9, wherein, (where applicable), said inflator nozzle means can be excluded from said support devices in said combinations, whereby, said combinations can be pre-filled with air, or, helium gas, or, hydrogen gas;

11) An invisible and/or non-invisible designed inflatable combined with electric (battery operated) black ultra violet light(s) and inflator nozzle fixture accessories, as set forth in any one of claims 1, 2, 3, 4, 5, 6, 7, 8, 9, and 10, wherein, (where applicable), said lighting means in said support devices comprises one or more of the usable methods described, which are:
a) one or more black ultra violet light bulbs;
b) said one or more black ultra violet light bulbs may be open faced and/or reflector flange directed;
c) one or more white light bulbs, or of any other colors;
d) said bulbs in (c) may be open faced or reflector flange directed;
e) said bulbs in (a) and (b) can be combined with bulbs in (c) & (d);
f) said bulbs can be LED energy efficient bulbs;
g) said bulbs can be fluorescent bulbs;
h) said bulbs can be incandescent bulbs;
i) said bulbs can be xenon bulbs;
j) said bulbs can be halogen bulbs;
k) said bulbs can be krypton bulbs;
l) said bulbs can be miniature flood light bulbs;
m) said bulbs can be laser light bulbs, or, system;
n) said bulbs can be of any other light emitting bulb or diode;
o) said bulbs are directly connected to said lighting means in said support devices using any type of known attaching, connecting and threading means respectable by method;
p) said bulbs in (a) & (b) can be Simulation to Stimulation, whereby, one black ultra violet light bulb may be substituted with a red light bulb and a blue light bulb combined together in one reflector flange, as a simulation; said lights and illuminations from said simulation combination of red and blue light bulbs in said reflector flange are converted into violet light-illuminations to stimulate fluorescent paint means and phosphorescent paint means, much like and somewhat similar to said black ultra violet light bulb;
